(19) United States
(12) Patent Application Publication
(10) Pub. No.: US 2011/0229692 A1
(43) Pub. Date: Sep. 22, 2011

(54) BASE FOR A FLOOR MAT

(76) Inventors: Eric Bozouklian, Maisons-Lafitte (FR); Bernard Vincent, Rueil Malmaison (FR); Sylvain Masson, Montoir de Bretagne (FR); Guy M. Pollaud, St. Germain en Laye (FR); David R.B. Williams, Almunge (SE); Cecile Hoehler, Grevenbroich (DE); Eduard Van Engelenburg, Anna van Bureniaan (NL)

(21) Appl. No.: 12/595,977

(22) PCT Filed: Apr. 14, 2008
(86) PCT No.: PCT/US08/60216

§ 371 Date: Apr. 29, 2010

(30) Foreign Application Priority Data
Apr. 16, 2007 (GB) 0707268.9

(51) Int. Cl. B32B 3/30

(52) U.S. Cl. 428/156

(57) ABSTRACT

A base (2) for a floor mat (1) is composed of a plurality of components that are releasably-secured together to define at least one recess, for receiving matting material (3), and a ramp-like edge (4) that inclines upwardly from the level of the floor surface to the level of the upper surface of the mat. In some embodiments, the ramp-like edge may extend without interruption around the entire periphery of the base. In other embodiments, in which the base is generally rectangular, the ramp-like edge may extend without interruption along only two opposed sides of the base. Advantageously, the height of the walls of the/each recess is such that the tops of the walls are at the level of the upper surface of the mat.

### CROSS-REFERENCE TO RELATED APPLICATIONS

The present application claims priority to United Kingdom Application Serial No. 0707268.9, filed on Apr. 16, 2007, the entirety of which is incorporated herein by reference.

### FIELD OF THE INVENTION

The present invention relates to floor mats, more especially floor mats that are suitable for use at the entrances of buildings or similar locations.

### BACKGROUND

Entrance mats are used to remove dirt and water (hereinafter referred to generally as “soil”) from the shoes of pedestrians as they enter a building. In some locations, for example supermarket and airport buildings, entrance mats are also required to remove dirt and water from the wheels of trolleys or similar articles. Accordingly, reference herein to the removal of soil from the shoes of pedestrians should be considered to include the removal of soil from all traffic (pedestrian and wheeled) that passes over an entrance mat.

Various forms of entrance mat are known and, depending on their construction and the materials from which they are formed, are placed immediately outside or inside a building. Entrance mats can be installed in a recess well in a floor or laid directly on the floor as a drop-down mat. It is also known to provide a permanent base on a floor, onto which a mat can be laid, and taken up as required for cleaning or replacement. Such bases offer the advantage of containing the mat so that it remains in a selected position when in use but can, nevertheless, be moved to another position if required. They also contain any soil that falls through the mat and prevent it from spreading onto, or damaging, the floor. Some bases additionally provide a ramp-like edge at the periphery of the mat, which facilitates the passage of traffic over the mat and reduces the risk of pedestrians tripping on its edge.

Examples of mat bases are described in U.S. Pat. No. 4,609,580 (Rockett et al); U.S. Pat. No. 5,018,235 (Stamatiou et al); and PCT Publication No. WO 00/16682 (Yamaguchi et al). Those bases can accommodate a mat of one size only so that a variety of bases of different shapes and sizes would be required to accommodate the wide range of spaces in which entrance mats are used.

PCT Publication No. WO 99/53811 (Nordin) describes a mat base that is composed of modular units, for use with a textile layer to provide a mat that is adjustable both in terms of length and breadth.

The mat base has flanges along two opposed sides to receive edges of the textile material, the latter being folded under the base at each end. The base can, according, only be used with thin and foldable textile material and is not suitable for use with regular floor matting material. U.S. Pat. No. 5,142,733 (Mogel et al) proposes the use of a plurality of mat holders that can be connected together to form a larger mat but without a continuous edge at its periphery. The larger mat also has a series of valleys across its surface, marking the junctions between the mat holders, which could be inconvenient to pedestrians and difficult for wheeled traffic to negotiate.

The present invention is concerned with the problem of providing a cost-effective mat base that can readily be adapted for different sizes of mats.

The present invention provides a base for a floor mat, the base being generally rectangular and composed of a plurality of components that are releasably-secured together to define at least one recess, for receiving matting material, and a ramp-like edge that inclines upwardly from the level of the floor surface to the level of the upper surface of the mat and extends without interruption along at least two opposed sides of the base.

Preferably, the ramp-like edge extends without interruption around the entire periphery of the base. The present invention accordingly also provides a base for a floor mat, the base being composed of a plurality of components that are releasably-secured together to define at least one recess, for receiving matting material, and a ramp-like edge that inclines upwardly from the level of the floor surface to the level of the upper surface of the mat and extends without interruption around the entire periphery of the base.

### BRIEF DESCRIPTION OF THE DRAWINGS

By way of example only, embodiments of the invention will now be described with reference to the accompanying drawings, in which:

FIG. 1 is a perspective view of a floor mat;

FIG. 2 shows the base of the floor mat of FIG. 1, assembled from a plurality of components;

FIGS. 3 and 4 are similar to FIG. 2 but show the base assembled from different components;

FIG. 5 is a diagrammatic plan view illustrating the assembly of a mat base from four components;

FIG. 6a-6d shows the four components used to assemble the base of FIG. 5;

FIG. 7 shows a base that has been assembled from three of the components shown in FIG. 6;

FIG. 8 shows a mat base similar to that of FIG. 7 but assembled from different components;

FIG. 9 illustrates another mat base assembled from a plurality of components;

FIG. 10 illustrates a modification of the mat base of FIG. 9;

FIGS. 11 to 13 illustrate the assembly of other mat bases from a plurality of components;

FIGS. 14 and 15 illustrate one form of connection system for connecting together the components of a mat base;

FIGS. 16a, 16b and 17 illustrate other forms of connection system; and

FIG. 18 shows the underside of a component of a mat base.

### DETAILED DESCRIPTION

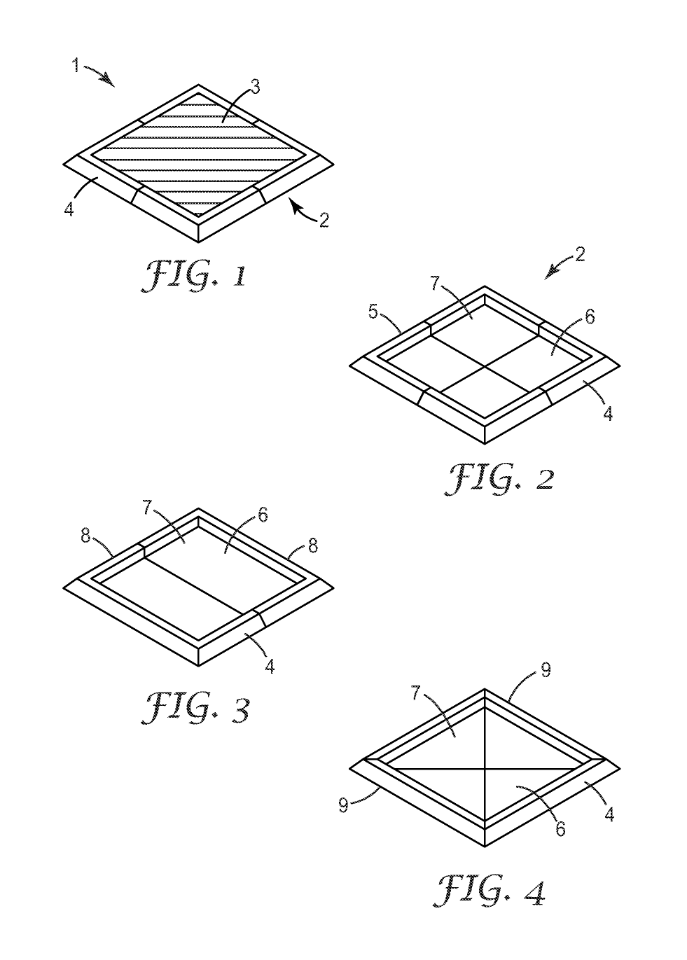

The mat 1 shown in FIG. 1 comprises a base 2 in the centre of which is a recess that is filled by matting material 3. As described below, the base 2 is composed of a plurality of components that fit together to define both the recess and also a ramp-like edge 4, which inclines upwardly from the surface of the floor (not shown) on which the mat is located to the level of the upper surface of the matting material 3, corresponding to the upper surface of the mat 1. The edge 4 facilitates the passage of traffic over the mat and reduces the risk of pedestrians tripping on its edge and, in this case, extends without interruption around the whole periphery of the base 2.

The inclination of the ramp-like edge 4, which will determine its maximum height and its width, is selected to provide an easy passage over the mat. An angle of inclination relative to the floor of around 15° is normally appropriate but can be varied depending on the situation. The depth of the recess in the base 2 will be determined by the thickness of the matting material 3 that it is intended to accommodate: typical matting material will have a thickness in the range of from around 6 mm to around 27 mm, but other thicknesses are possible.

The matting material 3 is advantageously removably-located in the recess in the base 2 so that it can be taken out to allow the recess to be cleaned, or so that the matting material can be replaced, for example when it becomes worn or dirty.

The mat 1 of FIG. 1 is square in shape, and FIG. 2 shows how its base 2 can be assembled from four identical components 5, each comprising a respective corner of the base and one half of the two adjacent edges 4 along with the associated quarter of the floor 6 of the recess 7. The components 5 are releasably-secured together in any suitable way so that they can be taken apart and, if required, used in combination with additional compatible components to form a base of a different size and shape. Suitable connection systems for connecting together the components 5 will be described below.

FIGS. 3 and 4 show a similar base 2 assembled from different components. In FIG. 3, the base is assembled from two identical components 8, each comprising two respective corners of the base, one complete edge 4 and one half of the two adjacent edges 4 along with the associated half of the floor 6 of the recess 7. In FIG. 4, the base is assembled from four identical components 9, each comprising one respective edge 4 and one half of the corners at each end along with the associated quarter of the floor 6 of the recess 7.

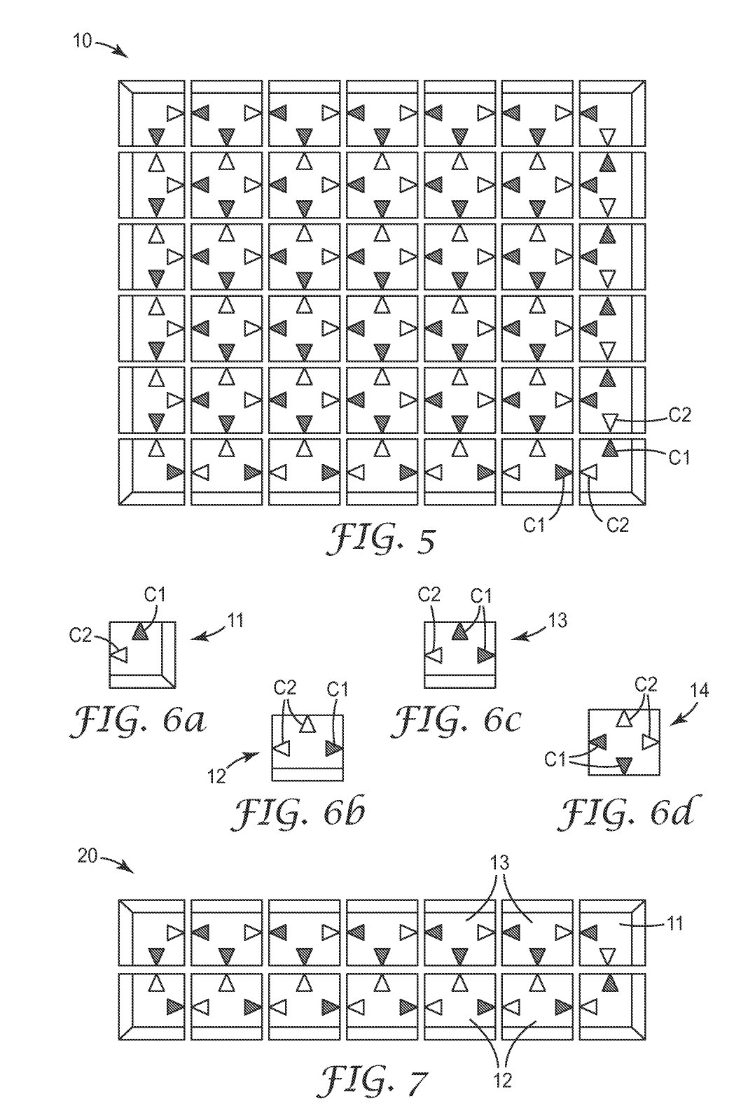

FIG. 5 illustrates how a larger base 10 can be assembled economically from only four different types of components, assuming that the same type of connection is used throughout between adjacent components. In FIG. 5, this connection is indicated by a dark triangle C1 on the edge of one component and a light triangle C2 on the edge of an adjacent component. The four types of components used in FIG. 5 are shown in FIGS. 6a to 6d and comprise one type of corner component 11 (FIG. 6a); two types of edge components 12, 13 (FIGS. 6b and 6c), which differ only as regards the combination of connection components C1, C2; and one type of interior component 14 (FIG. 6d). As an alternative, a similar base could be assembled using one type of corner component, one type of edge component and two types of interior component.

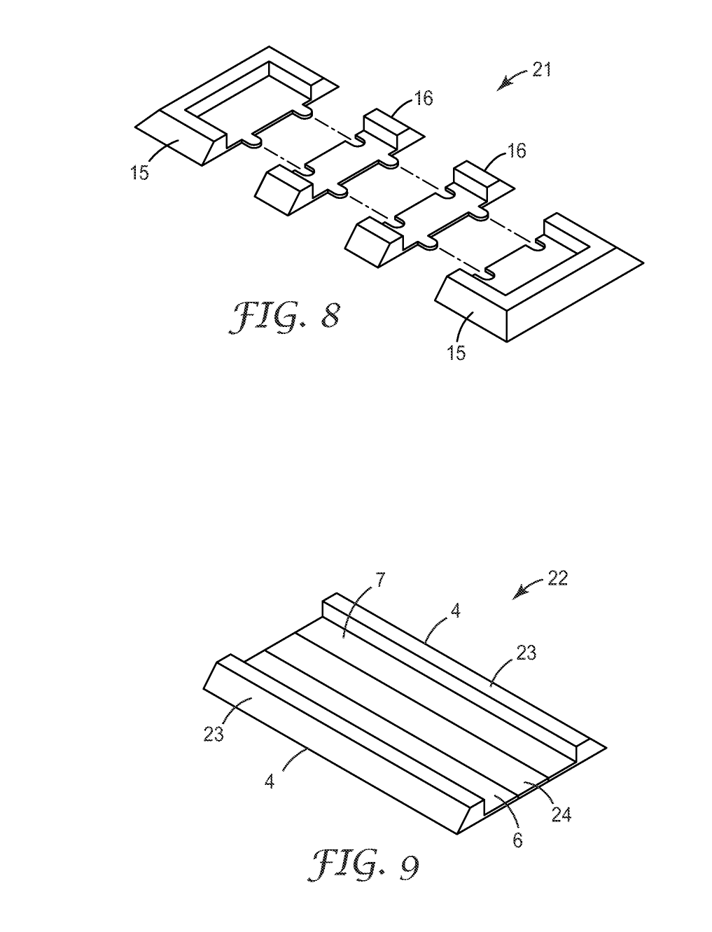

FIG. 7 illustrates how an elongate base 20 can be assembled using only the corner and edge components 11, 12, 13 of FIGS. 6a to 6c. Alternatively, as illustrated in FIG. 8, an elongate base 21 can be assembled using two end components 15, similar to the components 8 of the base of FIG. 3, and one or more intermediate components 16. The connection between the components in FIG. 8 is shown schematically only: preferred connection systems will be described below.

The components of the bases described with reference to FIGS. 2 to 8 can be produced by any appropriate manufacturing process, most suitably a moulding process. As a further alternative, a base that is formed from extruded components is illustrated in FIG. 9. The base 22 of FIG. 9 differs from those described with reference to FIGS. 2 to 8 in that a ramp-like edge 4 is present on only two opposed sides of the base: consequently, in use, a mat comprising the base 22 should be positioned so that the edges 4 extend transversely to the normal direction of traffic across the mat. The base 22 comprises two identical outer components 23, each extending the length of the base and comprising one of the edges 4 and an adjacent part of the floor 6 of the recess 7, and an interior component 24 which also extends the length of the base and comprises the central part of the floor 6. The connection (not visible) between the components 23, 24 is such that the components can all be produced, by an extrusion process, to the length required for the base 22. An example of a suitable connection system will be described below.

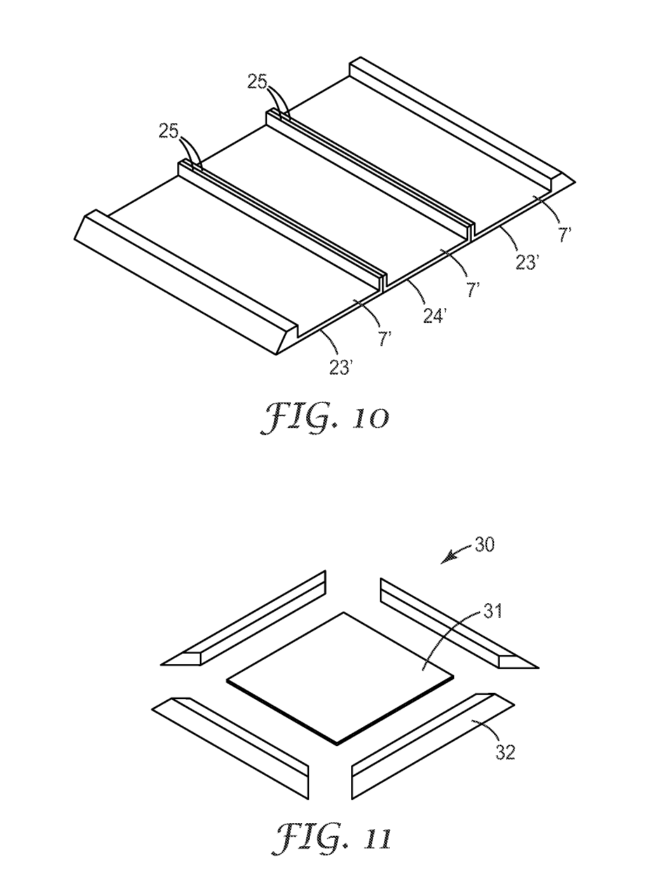

FIG. 10 illustrates a modification of the base 22 of FIG. 9, in which the outer components 23′ and the inner component 24′ are formed with upstanding walls 25 where they adjoin one another. The walls 25 extend the length of the base so that the base effectively comprises three lengthwise-extending recesses 7′ for receiving matting material, rather than a single recess as in FIG. 9. The upper surfaces of the walls 25, like the tops of the ramp-like edges 4, should be level with the upper surface of the matting material located in the recesses 7′ so that the completed mat will present a continuous, level, surface to the traffic that passes over it.

If desired, some form of edging could be secured to the ends of the bases of FIGS. 9 and 10, to completely enclose the recess 7 or recesses 7′. This additional edging could be secured in any suitable way and could, if desired, provide ramp-surfaces at the ends of the base similar to those provided by the edges 4. The additional ramp-like surfaces are, however, not essential if, as described above, a mat incorporating the base is positioned for use so that the edges 4 extend transversely to the normal direction of traffic across the mat.

FIG. 11 is an exploded view that illustrates an alternative way of assembling a base 30 with a ramp-like edge around its entire periphery. In this case, a rectangular floor layer 31 having the required peripheral dimensions of the base is first provided. The floor layer may be cut from a length of suitable material provided, for example, in roll form. Four edge pieces 32, each having the length of a respective side of the floor layer, are also provided. The edge pieces 32 have a generally wedge-shaped cross-section, corresponding to the required shape of the ramp-like edges 4, and may also be cut from a length of suitable material provided, for example, in roll form. The edge pieces 32 (which are shown separated from the floor layer 31 in FIG. 11) are then attached in any suitable way over the margins of the floor layer 31, having previously been shaped to form mitres at the corners of the base 30 to provide an edge that extends without interruption around the entire periphery of the base. The attachment of the edge pieces 32 to the floor layer 31 may be by means of reclosable fasteners, enabling the base to be dismantled if required, or it may be a permanent attachment by means of an adhesive.

The construction of another base 35 that comprises separate edge pieces 36 is illustrated in FIG. 12, which is also an exploded view. In this case, the centre of the base comprises a plurality of components 37 that are releasably-connected together, each having a respective recess 38 for receiving matting material. Once the components 37 have been assembled in the desired configuration, the edge pieces 36 (which are shown separated from the centre of the base in FIG. 12) are secured in position around the periphery, having previously been shaped to form mitres at the corners at the corners of the base 35 to provide an edge that extends without interruption around the entire periphery of the base. The completed mat will thus comprises a plurality of separate pieces of matting material arranged, in the manner of tiles, in the various recesses 38. As described above with reference to FIG. 10, the upper surfaces of the walls of the recesses 38 should all be level with the upper surface of the matting material located in the recesses so that the completed mat will present a continuous, level, surface to the traffic that passes over it.

The edge pieces 36 can be secured to the centre pieces 37 of the base 35 in any suitable manner that permits the base to be dismantled and the components re-used if required. The edge pieces 36 and the centre pieces 37 could, for example, each be provided with one part of a two-part mechanical connection of the type described below with reference to FIGS. 16a and 16b.

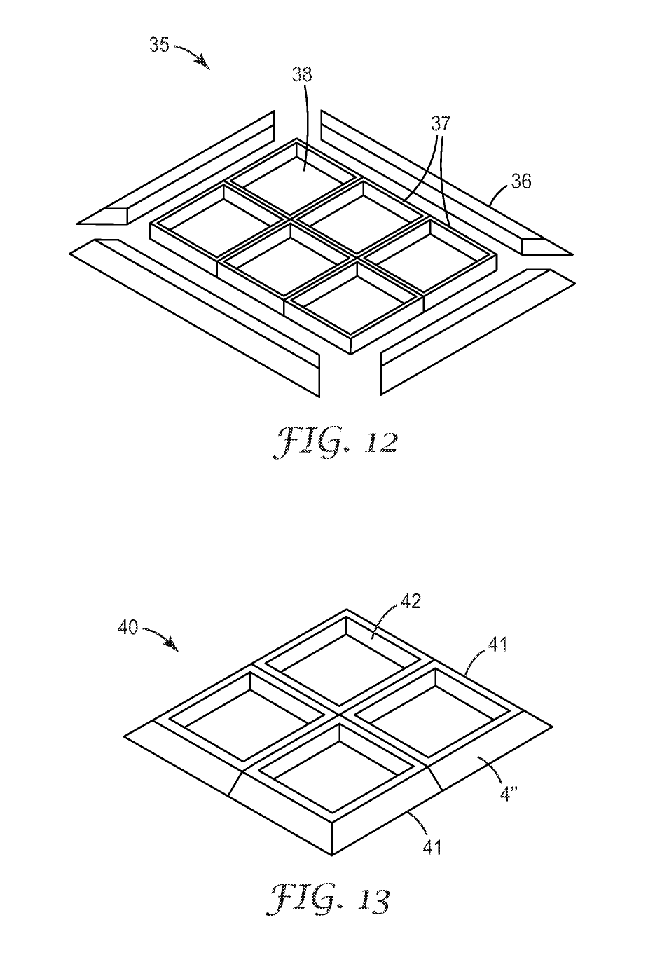

FIG. 13 shows another base 40 that provides a plurality of recesses for receiving separate pieces of matting material. In this case, the ramp-like edge 4″ that extends without interruption around the entire periphery of the base 40 is not formed from separate edge pieces but, as in FIGS. 2 to 8, in sections that are integral parts of the components 41 from which the base is formed. The components 41 are releasably-connected together in any suitable manner, and each component has a respective recess 42 in which a suitably-shaped piece of matting material is located. In this case also, the upper surfaces of the walls of the recesses 42 should all be level with the upper surface of the matting material located in the recesses so that the completed mat will present a continuous, level, surface to the traffic that passes over it.

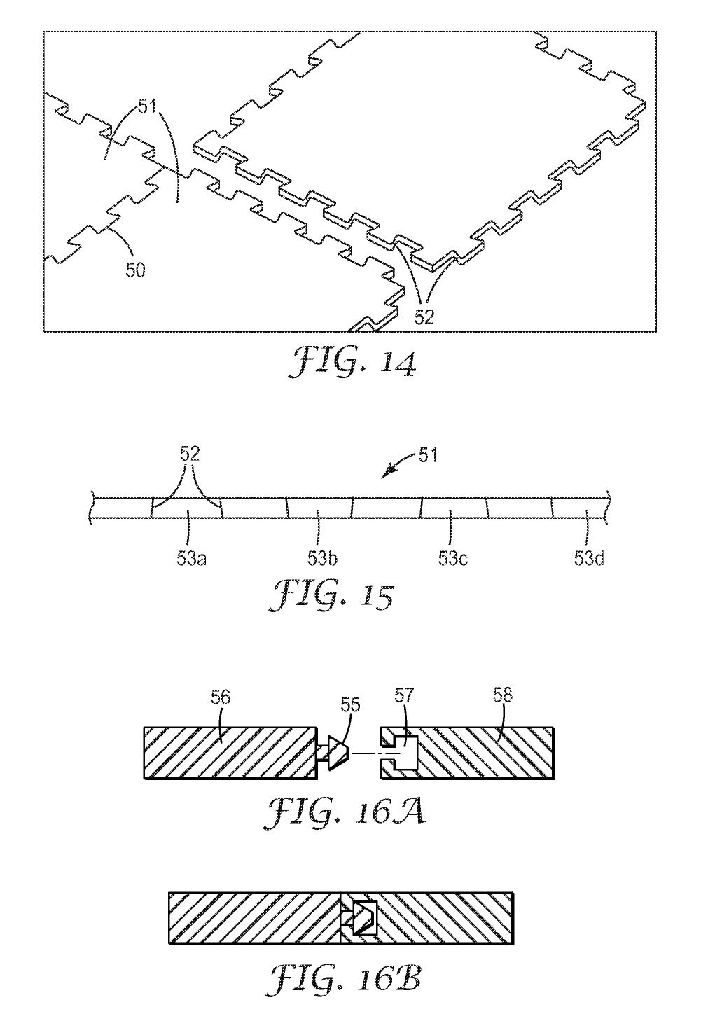

Connection systems that can be used to connect together the components of the above-described bases are illustrated in FIGS. 14 to 17 and described below. As will be apparent, the connection system employed should be selected having regard to the type of component with which it is to be used.

FIG. 14 is a perspective view showing a connection system that comprises a series of mortise-and-tenon type joints 50 along the adjacent edges of two components 51. Each mortise/tenon has a dovetail shape so that a relative vertical movement between the components 51 is required to connect them together and, subsequently, to separate them. Advantageously, the sides 52 of each tenon are inclined slightly from the vertical with the direction of inclination alternating from one to the next: this is illustrated in the side view of FIG. 15 which shows that the sides 52 of tenon 53a diverge slightly from one another in the direction from the top surface to the bottom surface of the component, while the sides 52 of the adjacent tenon 53b converge and so on for the other tenons 53c, 53d etc. The result of this is that a degree of pressure is required to connect the components 51 together and, subsequently, to separate them and this, in turn, helps to prevent the components being unintentionally separated, particularly when matting material is being removed from the recess(es) in the base.

FIGS. 16a and 16b are cross-sectional views that illustrate a connection system that requires a relative horizontal movement between two components to connect them together (FIG. 16b) and, subsequently, to separate them (FIG. 16a). In this case, a projecting stud 55 on a side edge of one component 56 is a push-fit in a recess 57 in the other component 58. The stud 55 has a shaped head that prevents unintentional separation of the components 56, 58 when the mat base is in use. A plurality of such connector studs/recesses could be provided along one edge of a component, if required.

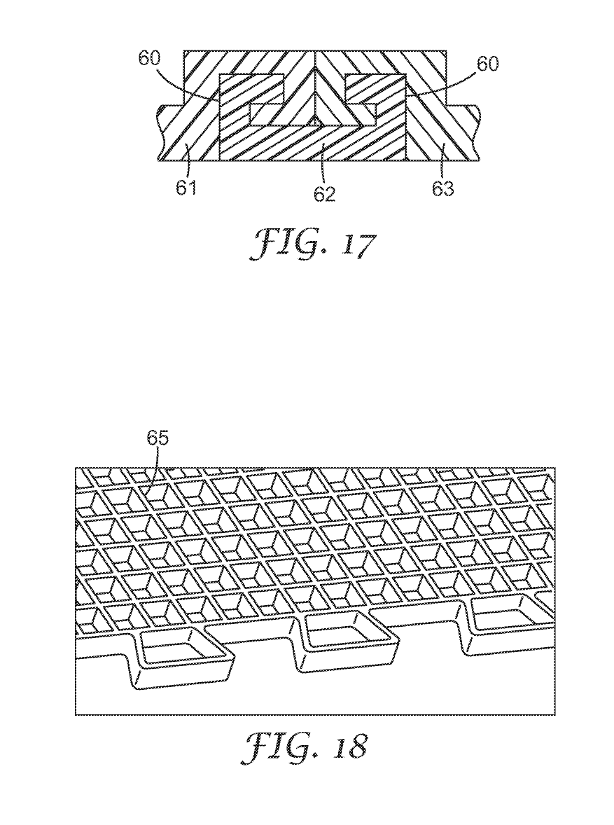

FIG. 17 illustrates a connection system that is especially, but not exclusively, suitable for extruded components such as those of the bases illustrated in FIGS. 9 and 10. In this system, an appropriately-shaped groove 60 is formed in the underneath side of a component 61, along the edge at which it will be connected to an adjacent component. A connection piece 62 is inserted into this groove and into a similar groove in the adjacent component 63, and thus connects the two components together.

It will be appreciated that other forms of connection systems could be used, as appropriate, to connect together the components of a mat base provided that they do not result in, or permit, the formation of gaps between the components.

The floor-contacting surface of a mat base as described above is advantageously configured to inhibit movement of the base relative to the floor. This may be achieved, for example, by the provision of an anti-slip material or pattern on the floor-contacting surface. FIG. 18 shows the lower surface of a component of a mat base (in this case, one of the components 51 of FIG. 14) provided with intersecting ribs 65, which also help to achieve a more rigid structure without an undesirable increase in weight. It will be appreciated that any of the components of any of the other mat bases described above could have a similar construction.

Any suitable matting material can be used with a mat base of the type described above with reference to the drawings. One suitable material is described in our patent applications GB0620895.3 of 20 Oct. 2006 and GB0703428.3 of 22 Feb. 2007. Preferably, the matting material is releasably-secured to the floor of the recess in the mat base, to prevent the material moving relative to the base when the mat is in use. The floor of the recess may, for example, be provided with a plurality of hooks that engage directly with the matting material, or with a loop fabric attached to the bottom surface of the matting material. As an alternative, repositionable adhesive tapes could be used to secure the matting material to the floor of the recess. As already described, the depth of the recess in the mat base should be such that the upper surface of the matting material is level with the top of the ramp-like edges of the base.

Although the mat bases shown in the drawings are all rectangular, it will be appreciated that bases with other shapes could be constructed in a similar manner. It will also be appreciated that other shapes are possible for the recesses in which the matting material is located.

1-18. (canceled)

19. A base for a floor mat, the base being generally rectangular and composed of a plurality of components that are releasably-secured together to define at least one recess, for receiving matting material, and a ramp-like edge that inclines upwardly from the level of the floor surface to the level of the upper surface of the mat and extends without interruption along at least two opposed sides of the base.

20. A base as claimed in claim 19, wherein the ramp-like edge extends without interruption around the entire periphery of the base.

21. A base for a floor mat, the base being composed of a plurality of components that are releasably-secured together to define at least one recess, for receiving matting material, and a ramp-like edge that inclines upwardly from the level of the floor surface to the level of the upper surface of the mat and extends without interruption around the entire periphery of the base.

22. A base as claimed in claim 21, wherein the height of the walls of the recess is such that the tops of the walls are at the level of the upper surface of the mat.

23. A base as claimed in claim 22, wherein the components are secured together without noticeable gaps therebetween.

24. A base as claimed in claim 23, wherein the components are so shaped that at least some of them can be re-used to form a base that also has a ramp-like edge extending around at least a part of its periphery but comprises at least one recess with a different size/shape.

25. A base as claimed in claim 24, wherein at least some of the components are shaped to provide both a part of the floor of the recess and a part of the ramp-like edge.

26. A base as claimed in claim 25, in which at least two of the components are identical.

27. A base as claimed in claim 26, wherein some of the components are shaped to provide only a part of the floor of the recess, and the remainders are shaped to provide only a part of the ramp-like edge.

28. A base as claimed in claim 27, wherein one of the components is shaped to provide the entire floor of the recess, and the remainders are shaped to provide only a part of the ramp-like edge.

29. A base as claimed in claim 28, wherein the components are moulded/extruded components.

30. A base as claimed in claim 29, wherein the floor of the recess comprises means for engaging and retaining matting material received in the recess.

31. A base as claimed in claim 29, wherein the components are releasably-secured together by means that are an integral part of the components.

32. A base as claimed in claim 31, wherein the components are releasably-secured together by means that are shaped to resist separation of the components in a direction generally parallel to the plane of the floor.

33. A base as claimed in claim 32, wherein the components are releasably-secured together by means that are shaped to resist separation of the components in a direction generally perpendicular to the plane of the floor.

34. A base as claimed in claim 33, wherein the floor-facing side of the components is configured to resist movement of the base relative to a floor surface.

35. A floor mat comprising a base as claimed in claim 21, and matting material removably-located on, and covering, the floor of the recess.

36. A floor mat as claimed in claim 35, wherein the matting material is sufficiently thick to extend to the top of the recess.
